(19) United States
(12) Patent Application Publication
(10) Pub. No.: US 2009/0249216 A1
(43) Pub. Date: Oct. 1, 2009

(54) INTERACTING WITH MULTIPLE BROWSERS SIMULTANEOUSLY USING LINKED BROWSERS CONTROLLED FROM A PRIMARY BROWSER INTERFACE

(75) Inventors: AL CHARKA, APEX, NC (US); YONGCHENG LI, CARY, NC (US); YUPING C. WU, CARY, NC (US)

Correspondence Address: PATENTS ON DEMAND, P.A. IBM-RSW, 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 12/057,974

(22) Filed: Mar. 28, 2008

(51) Int. Cl. G06F 3/048

(52) U.S. Cl. 715/744

(57) ABSTRACT

A Web application can be loaded into a set of different Web browsers. A set of user interactions directed to one of the Web browsers can be received. A state of that Web browser can be altered in accordance with each user interaction. For each received user interaction, an equivalent interaction data element can be conveyed to each of the other Web browsers. The equivalent interaction data element can emulates the received user interaction in context of the Web browser for which the equivalent interaction data is intended. A state of each of the other Web browsers can be altered in accordance with the equivalent interaction data that is received and processed by that Web browser.

### BACKGROUND OF THE INVENTION

The present invention relates to the field of Web development and, more particularly, to interacting with applications in multiple browsers simultaneously using linked browsers controlled from a primary browser interface.

Web development has been long plagued by inefficient and time consuming cross browser testing methodologies necessary to produce Web sites and Web applications. A method commonly employed is the manual testing of each browser against the application and/or site being developed. As such a task is extremely time intensive, large teams of software testers can often be used to combat the sheer volume of testing necessary. Testers however, may not be intimately familiar with the expected behavior and function of an application/site and can produce misleading and/or erroneous testing results. To reduce this possibility, developers themselves are often relegated to testing the product and/or to reviewing possible defects noticed by a testing team. This however, can exponentially increase the time an application/site is able to be deployed, hinder the ability of a developer to focus on core develop tasks, and reduce the quality of the developer's primary job function.

Recently, advances have been made to correct this shortcoming in the Web development cycle. As a result, testing suites have been produced that aid Web developers in effectively testing Web applications and Web sites. One approach uses scripts to drive test cases against a selected set of browsers of interest. Such testing suites however, still consume a large amount of development time because they often require additional programming such as test case creation and validation. This approach typically allows developers to take screen captures of browser at any particular moment during the testing phase. While useful, this is a static, non-interactive approach which distances the developer from the process. Since developers cannot directly inspect the browsers during testing and make necessary changes and tweaks, there is often a great deal of repetitive testing. For example, when a graphical layout problem is detected, the test process must be stopped, a fix must be performed, and the testing process must be restarted to ensure the layout problem is corrected. Today's scripting solutions rarely notice GUI interface idiosyncrasies and instead focus upon situations that cause an application to “crash” entirely, which can be considered catastrophic errors. A majority of browsers are somewhat compatible, so interface interpretation quirks are more common and more difficult to detect than catastrophic errors.

Interactivity during testing is crucial since large complicated Web applications can perform drastically different from browser to browser. Interactive problems are often only discernable by a human operator, since problematic behavior is idiosyncratic by definition and often requires a level of situational and subjective judgment to be applied. Further, a flexible, interactive, and natural testing methodology does not currently exist. Existing technologies have yet to present a solution that reduces testing time and allows an interactive testing approach.

### BRIEF SUMMARY OF THE INVENTION

One aspect of the present invention can include a method, apparatus, computer program product, and system for testing Web applications. A Web application can be loaded into a set of different Web browsers. A set of user interactions directed to one of the Web browsers can be received. A state of that Web browser can be altered in accordance with each user interaction. For each received user interaction, an equivalent interaction data element can be conveyed to each of the other Web browsers. The equivalent interaction data element can emulate the received user interaction in context of the Web browser for which the equivalent interaction data is intended. A state of each of the other Web browsers can be altered in accordance with the equivalent interaction data that is received and processed by that Web browser.

Another aspect of the present invention can include a system for linking multiple browser interfaces that includes a primary browser interface one or more dependent browser interfaces, and browser interface linkage executable code. The primary browser interface can be configured to load a primary instance of an application, to receive input for said primary instance of the application, and to present output for said primary instance of the application. Each dependent browser interface can be configured to load a dependent instance of the application, to receive input for the dependent instance of the application, and to present output for the dependent instance of the application. The browser interface linkage executable code can link the primary browser interface and the dependent browser interfaces so that input to the primary browser interface is automatically conveyed for use by each of the dependent browser interfaces.

### BRIEF DESCRIPTION OF THE SEVERAL VIEWS OF THE DRAWINGS

FIG. 1 is a schematic diagram illustrating a system for interacting with Web applications in multiple browsers using programmatic linkages to a controlling primary browser interface in accordance with an embodiment of the inventive arrangements disclosed herein.

FIG. 2 is a diagram showing a set of interfaces for configuring a browser linkage system in accordance with an embodiment of the inventive arrangements disclosed herein.

FIG. 3 is a flow chart of a method for implementing linked browsers in accordance with an embodiment of the inventive arrangements disclosed herein.

FIG. 4 is a flow chart of a method for script driven intra-linked cross browser testing in accordance with an embodiment of the inventive arrangements disclosed herein.

### DETAILED DESCRIPTION OF THE INVENTION

The present invention discloses a solution for testing Web applications in multiple browsers simultaneously using linked browsers controlled from a primary browser interface. In the solution, a primary browser interface can be utilized to simultaneously control one or more dependent browsers. Dependent browsers can be presented in a visible, partially visible (e.g., transparent), or hidden state based on user configuration and device presentation restraints. Operations performed in the primary browser can trigger identical operations in the dependent browser. These operations can occur dynamically, concurrently, and in real-time. In one embodiment, behavior of dependent browsers can trigger alerts and/or warnings which can be presented to notify the user of potential problems with the Web application. In addition to manual testing procedures, automated testing can be performed by user created and/or automatically generated scripts. Further, interactions with the primary browser can be recorded within a script so that a test sequence can be re-executed against the primary browser and/or against any of the dependent browsers after an arbitrary delay.

The present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. Examples of a computer-readable medium include a semiconductor or solid state memory, magnetic tape, a removable computer diskette, a random access memory (RAM), a read-only memory (ROM), an erasable programmable read-only memory (EPROM or Flash memory, a rigid magnetic disk and an optical disk. Current examples of optical disks include compact disk-read only memory (CD-ROM), compact disk-read/write (CD-R/W) and DVD. Other computer-readable medium can include a transmission media, such as those supporting the Internet, an intranet, a personal area network (PAN), or a magnetic storage device. Transmission media can include an electrical connection having one or more wires, an optical fiber, an optical storage device, and a defined segment of the electromagnet spectrum through which digitally encoded content is wirelessly conveyed using a carrier wave.

Note that the computer-usable or computer-readable medium can even include paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

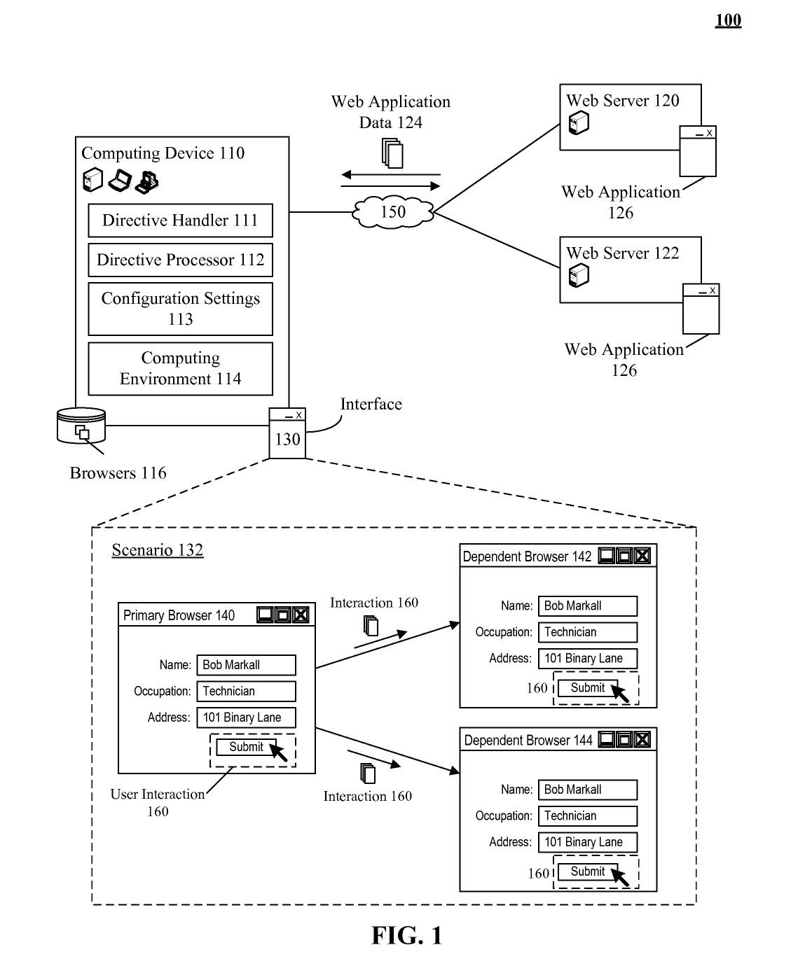

FIG. 1 is a schematic diagram illustrating a system 100 for interacting with Web applications in multiple browsers 142-144 using programmatic linkages to a controlling primary browser interface 140 in accordance with an embodiment of the inventive arrangements disclosed herein. In system 100, user interactions with browser 140 are detected by directive handler 111 and processed 112 as needed so that they are compatible with a target browser interface 142-144. Processed interactions 160 can be conveyed in real-time, which cause each browser interface 140-144 to perform approximately equivalent actions, even though a user only performs the actions in the primary browser interface 140. Processing by handler 111 and 112 can be needed since not all interactions with a primary browser interface 140 directly map to a dependent browser interface 142, 144 and some conversion to target browser standards is situationally needed. Each of the interfaces 140-144 can be associated with a corresponding browser 116 application.

While the browser linkage technique shown in system 100 can be beneficial in many situations, one contemplated use is in a testing context. That is, in a testing computing environment 114, a Web application 126 can be concurrently tested across multiple browsers 116 through a single user interaction scenario 132, where user input directs interactions with the primary browser interface 140, which causes equivalent interactions to occur in the dependent browsers interfaces 142, 144. In another context, system 100 can be used to link behavior of two or more remotely located browsers 116 together, thereby enabling a co-browsing session.

In a testing context, each of the browsers 116 can represent a different browser, browser version, browser configuration for which the Web application 126 is to be tested. Various configuration settings 113 can be established to permit a developer to configure a test scenario to his/her preference. For example, configuration settings 113 can determine that browser interfaces 140-144 are to be concurrently positioned in a non-overlapping manner upon a display (e.g., tiled or side-by-side). In another example, configuration settings 113 can determine that browser interface 140-144 are to be placed on top of one another with some degree of decreasing transparency from top to bottom. That is, you can “see through” topmost interfaces 140-144 to determine if lower layered interfaces 140-144 are performing identically to those above.

In yet another example, one set of settings 113 can permit the user interactions with browser interface 140 to be saved as a repeatable script or to be saved as a sequence of screen captured images so that problems identified by a tester can be recorded and/or conveyed to others. Additional optional scripts specific to a dependent browser interface 142, 144 can also be recorded as an interface specific script, which can execute independent of the primary browser interface 140. Another contemplated set of settings 113 can permit notifications to pop-up (or be suppressed) when an automated routine detects differences with browser interface 140-144 behavior.

In when embodiment, when differences or problems are detected with one of the linked browsers, the system 110 can be configured 113 to automatically identify-and-freeze in a state so that the differences or problem can be examined. This option can be particularly helpful in an embodiment where the primary browser 140 is being driven by a set of scripted actions, which in turn drive actions of the linked browsers 142-144. The identify-and-freeze option can automatically halt the script at a problematic state.

In another embodiment, multiple modes can exist affecting browser interface 140-144 linkages and user interactions with one or more of the interfaces 140-144. These modes can include a normal mode, in which interactions if interface 140 cause equivalent interactions to occur in all linked browser interfaces 142-144. Another interactive mode can be a lock-then-action mode. One implementation of the lock-then action mode can permit one or more of the browser interfaces 140-144 to be exclusively selected for user interactions, which the other non-selected interfaces 140-144 will not mimic. Another implementation of the lock-then-action mode can permit one or more browser interfaces 140-144 to be temporarily excluded from linked interactions performed by the other linked interfaces 140-144. Lock-the-action mode can allow a developer to interact with a single browser interface 140-144 without affecting the state of other browser interfaces 140-144.

A variant of this mode can be a training mode, where a selected interface can be synchronized to one of the other interfaces. For example, browser interface 142 can fail to properly emulate the submit action performed in interface 140. A user notice this, enter a lock-and-action mode to decouple interactive linkages for browser interface 142, and can train interface 142 so the its submit interface button is synchronized to the submit button of browser 140. Then training modes and the lock-then-action mode can be disabled and the normal mode, in which all browser interfaces 140-144 are linked, can continue.

The Web application 126 loaded in to the browsers 140-144 can execute from a data store local to device 110 or can be served from a remotely located Web server 120-122. In one embodiment, two or more different servers 120, 122 can be used, wherein one 120 represents a test or development environment used for testing and another 122 is a production server operating in a production environment. In networked situations, Web application data 124 can be exchanged among device 110, server 120, and server 122 via network 150.

As used herein, browsers 116 can include, but is not limited to, Web browsers, Web enabled interfaces, rich internet interfaces, and the like. Web browsers can include FIREFOX, OPERA, SAFARI, NETSCAPE, and the like. Browsers 116 can include different types of Web browsers and one or more revisions of a single browser type. Further, browsers 116 can include Web browsers not native to computing device 110 environment, executing in a virtualized environment. User interactions 160 can include keyboard input, mouse input, voice commands, tactile input, and the like.

In one embodiment, the primary browser interface 140 can be an interface uniquely constructed for linking interfaces 142-144 of different browsers 116 in accordance with details expressed in system 100. For example, the primary browser interface 140 can include only a minimal set of browser controls, which each of the browser interfaces 142 and 144 has. This minimalistic approach can circumvent potential mapping problems possible if a selection in the primary browser interface 140 is non-existent in one of the dependent browser interfaces 142-144.

Further in one embodiment, configuration options for dependent browser interfaces 142-144 can be limited by arrangements of browser interface 140. For example, a default arrangement or reference arrangement of toolbars, configurable controls, screen size, and the like can be established by the primary browser interface 140, to which dependent browser interfaces 142-144 must conform. In another embodiment, the interface 140 can be an interface of any of the browsers 116 being linked. In such an embodiment, a selection of an interface 140 control, interaction, option having no analog in a dependent browser interface 142-144 can be ignored, can be automatically detected and can cause a pop-up notice to be displayed, can cause an error to be thrown, and the like depending upon implementation desires.

The directive handler 111 can handle programmatic specifics relating to relaying interactions 160 directed to primary browser interface 140 to dependent browser interfaces 142-144. Directives refer to commands issued between multiple browsers 116, which direct the related interfaces 140-144 to perform as intended. For example, the directive handler 111 can handle timing, script recording, script playback, and the like for scenario 132. Directive handler 111 can also perform programmatic actions for the different linkage interaction modes, such as normal mode, lock-then-action mode, and a training mode.

The directive processor 112 can handle programmatic actions needed to adjust interactions 160 from one browser 140 interface to another 142-144. That is, different browser interfaces 140-144 can have different control arrangements, different hot-key assignments, different approximately equivalent options, and the like. The directive processor 112 can map these differences from one browser 116 to another. In a simple instance, the differences can be basic interface-level mapping differences. That is, GUI interactions (e.g., pointer positions, mouse clicks, key presses, item of focus, etc.) associated with browser interface 140 can be mapped to equivalent GUI interactions for browser interface 142 and 144. For example, submit button of interface 140 can be positioned at a bottom right corner of interface 140 and can be positioned at a bottom left corner of interface 142. The directive processor 112 can map these differences, one to another. In one embodiment, a training module can permit a user to re-map these interface differences, where user mappings are stored and applied to future interactions 160.

In another implementation of system 100, interactions 160 with the primary browser interface 140 can be converted into browser-recognizable events. These events can be conveyed to the browsers 116 associated with the dependent browser interfaces 142, 144. For example, a submit-selection-event can be determined based upon interactions with the primary browser interface 140. This submit-selection-event can be conveyed to browsers 116, which cause programmatic actions for the submit-selection-event to fire for each linked browser 116. Optionally, browser 116 code or interface overlay code can exist to shown emulated interactions within interface 142, 144 (e.g., move a mouse pointer and show a submit button being selected) relating to the submit-selection-event. In one embodiment, browser plug-ins for browsers 116 can be created and applied to ensure interfaces 140-144 of the browsers 116 behave as shown in scenario 132. In another embodiment, interfaces 140-144 shown in scenario 132 can be simulated interfaces of various interfaces of browsers 116 controlled by elements 111-113 of device 110. Use of simulated browser interfaces 140-144 can simplify mapping complications among interfaces, but can potentially lower a level of interactive realism when testing a Web application 126 for multiple browsers 116. When interactions 160 are translated into events, which are conveyed to browsers 116 shown by interfaces 140-144, use of simulated interfaces (so long as these interfaces reflect an application state of the underlying browsers 116 upon which events are executing) can be sufficient for many purposes of system 100.

The computing environment 114 can vary from implementation to implementation of system 100. For example, the computing environment 114 can be a test environment designed to simulate a production environment. The environment 114 can alternatively be a production environment in which the Web application 126 is being tested or is being concurrently utilized by multiple browsers 116 responsive to interactions initiated within a primary browser interface 140. For example, the system 100 can be utilized in a remote desktop situation, where one or more dependent browser interfaces 142-144 are controlled by the primary browser interface 140.

Web servers 120, 122 can be a software/hardware component capable of accepting and responding to hypertext transport protocol (HTTP) requests. Web servers 120, 122 can host Web application 126 which can include one or more Web-based applications, Web sites, Web services, and the like. Web servers 120, 122 can be implemented in a computer configured as a server, in a desktop computer, in a mainframe, in a server pool, and the like.

Computing device 110 can be a software/hardware component capable of presenting interface 130. Device 110 can be, but is not limited to, a desktop computer, a notebook computer, a personal data assistant (PDA), a mobile phone, a thin client, a portable computing device, and the like.

User interfaces 130, 140-144 presented herein are for illustrative purposes only and should not be construed to limit the invention in any regard. The user interfaces 130, 140-144 can be implemented as graphical user interfaces (GUIs), a voice user interface (VUI), a text interface, a multi-modal interface, and the like.

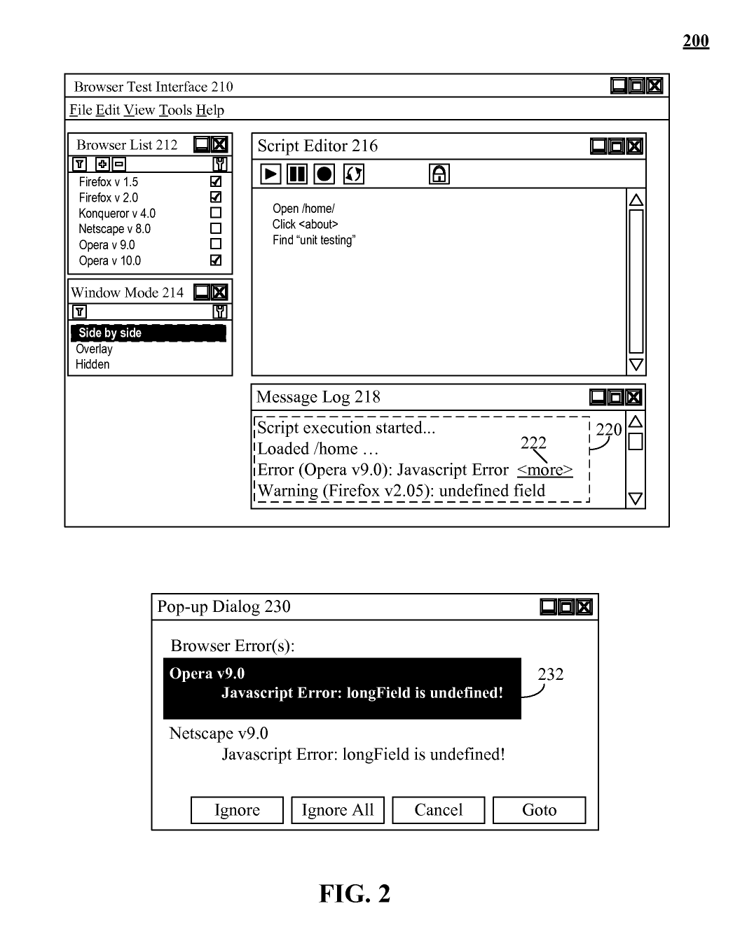

FIG. 2 is a diagram 200 showing a set of interfaces 210, 230 for configuring a browser linkage system in accordance with an embodiment of the inventive arrangements disclosed herein. Diagram 200 can be implemented in the context of system 100. Diagram 200 can be used in scenario where a developer is presented with an interface 210 for testing Web applications simultaneously in multiple browsers. Pop-up dialog 230 can be presented responsive to behavioral/layout errors, and/or warnings generated by browsers during testing. The interface controls, arrangements, and layout shown in interfaces 210 and 230 are for illustrative purposely only and are not intended to limit the underlying invention. Further, although shown as graphical user interfaces (GUIs), interfaces 210 and 230 are not so limited and can be implemented as voice user interfaces (VUI), text interfaces, multi-modal interfaces, and the like.

As shown, interface 210 can include browser list 212, window mode 214, script editor 216, and message log 218. Browser list 212 can present one or more browsers available for use in testing. Browsers can include different types of Web browsers and/or varying revisions of the same browser. For example, multiple versions of Firefox can be selected allowing developers to test a Web application in Firefox Version 1.5 and Version 2.0.

Window mode 214 can allow a developer to select the manner in which select browsers are presented during testing. One layout option can include the presentation of each selected browser simultaneously in a viewable screen area. In this approach, each browser window can be sized appropriately enabling all browsers to be visible during testing. Screen area can be calculated for each of the selected browsers, in addition to the primary browser. Based on the allotted screen space each browser can be presented side-by-side or tiled with the appropriate determined height and width. In one configuration, interface 210 can utilize one or more display devices spanning a single or multiple viewable areas for use in presentation of browsers during testing.

Alternatively, browsers can be presented with varying levels of alpha transparency allowing overlay placement of a browser over another. In this manner, layout positioning can be identified and verified, allowing developers to perform exact layout comparisons. For example, a highly transparent interface of a primary browser can be positioned exactly on top of a non-transparent interface of a dependent browser. This positioning can permit a developer to “see through” the interfaces to ensure that they are performing similarly.

In another embodiment, browsers can be hidden during testing appearing as an icon and/or placeholder element in interface 210. This means, the browser window is not presented, but a graphical image can be displayed to represent the presence of the browser. Interaction with browser placeholders can be initiated through conventional user input mechanisms. Notifications can be optionally presented to indicate when a hidden dependent browser is performing differently than a non-hidden primary browser. Additionally, scripting can be useful to permit a previously hidden interaction (e.g., one involving a hidden browser) to be repeated at a later time, as desired.

Script editor 216 can be a text editing component utilized to create, edit, and execute scripts for browser testing. Editor 216 can be utilized to control script execution allowing a script to be started, stopped, executed in discrete steps, and restarted. Editor 216 can include a text editing interface capable of hypertext markup language (HTML) element auto-completion, directive insertion, and the like. For example, developers can be assisted in script editing through the use of a directive library (not shown) which can present a list of browser commands used to simulate interaction in test browsers.

Message log 218 can be used to record various testing states, script execution, browser generated warnings, browser generated errors, and the like. For example, during script execution feedback from test browsers can be logged and presented as shown in section 220. During hidden modes, message log 218 can present a real time or near real time trace of script execution and/or browser messages. Messages in log 218 can be summarized based on user configured settings, making the message log more human readable. For example, error detail can be reached through a user interactive link as shown by entity 222. Interacting with link 222 can present pop-up dialog 230.

Pop-up dialog 230 can present browser generated errors and/or warnings that can occur during browser testing. Dialog 230 can be presented during tested or can be suppressed when browser warnings/errors occur based on user configured settings. Dialog 232 can be used to navigate to specific browsers by selecting an appropriate warning/error entry. For example, a user can be presented with the Opera version 9.0 browser by selecting error 232 and selecting the “Goto” button.

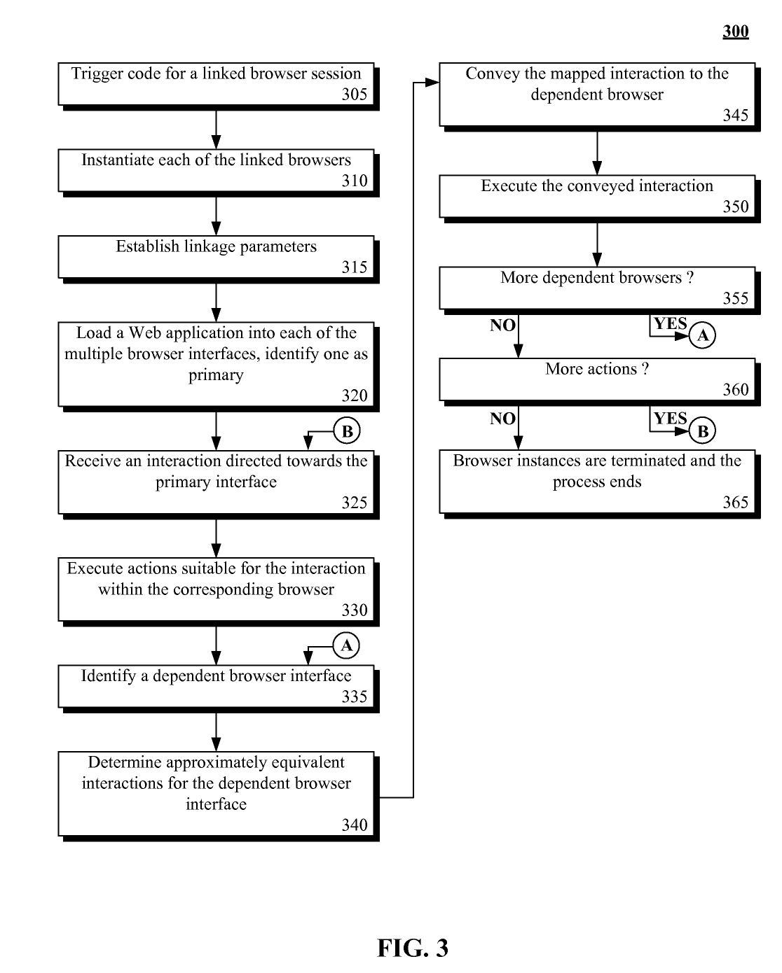

FIG. 3 is a flow chart of a method 300 for implementing linked browsers in accordance with an embodiment of the inventive arrangements disclosed herein. The method 300 can be performed in a context of system 100.

The method 300 can begin in step 305, where code can be triggered for a linked browser session. This can be triggered in context of a test for Web application, in a remote co-browsing context (involving different browsers), and the like. In step 310, each of the linked browsers can be instantiated as necessary so that the browser interfaces are active. In step 315, linkage parameters can be established, which includes browser specific ones and user customizations. In step 320, a Web application can be loaded into each of the multiple browser interfaces, one of which can be designated as a primary interface.

In step 325, an interaction (user or script driven) can be received for the primary Web interface. The associated browser can execute actions suitable for the interaction, as shown by step 330. In step 335 one of the linked browser interfaces, referred to as a dependent browser interface, can be identified. The interaction of the primary interface can be mapped to determine an approximately equivalent interaction for that dependent browser interface, as shown by step 340. In step 345 the mapped interaction can be conveyed to the related browser, which executes one or more browser actions in response, as shown by step 350. If more dependent browsers are linked to the primary browser, processing can loop from step 355 to step 335, where processing can be performed for a next one of those dependent browsers. Otherwise, the method can progress from step 355 to step 360, where a determination of whether more interactions with the primary are occurring/are to occur for the linked browser session. When more interactions are to occur, the method can progress from step 360 to step 325, as shown. When the session is over, step 365 can execute where the browser instances are terminated and the method ends.

Method 300 has defined behavior for interactions entered into a primary browser, which causes equivalent actions to occur in dependent browsers. Different implementation choices, which can be simultaneously implemented in a user configurable fashion, exist for behavior when input is directed towards one of the dependent browsers. In one embodiment, each dependent browser can be input “blocked” so that either a warning is presented that input is not permitted, or input directed to the dependent browser can be redirected to the primary browser. In an embodiment functionally similar to the redirection implementation, input can be directly accepted and processed by the dependent browser interface, which performs as if it were a primary browser interface.

In still another embodiment, input entered into a dependent browser can cause a state for that dependent browser to be saved, and can cause the dependent browser to handle the input in a stand-alone fashion, such that other ones of the linked browsers are unaffected. New input entered into the primary browser after actions have occurred within the dependent one, can cause the saved state to be loaded, were the dependent browser can thereafter function identically to other ones of the dependent browsers, which are all synchronized to an equivalent processing state from which interactions directed towards the primary browser interface are applied.

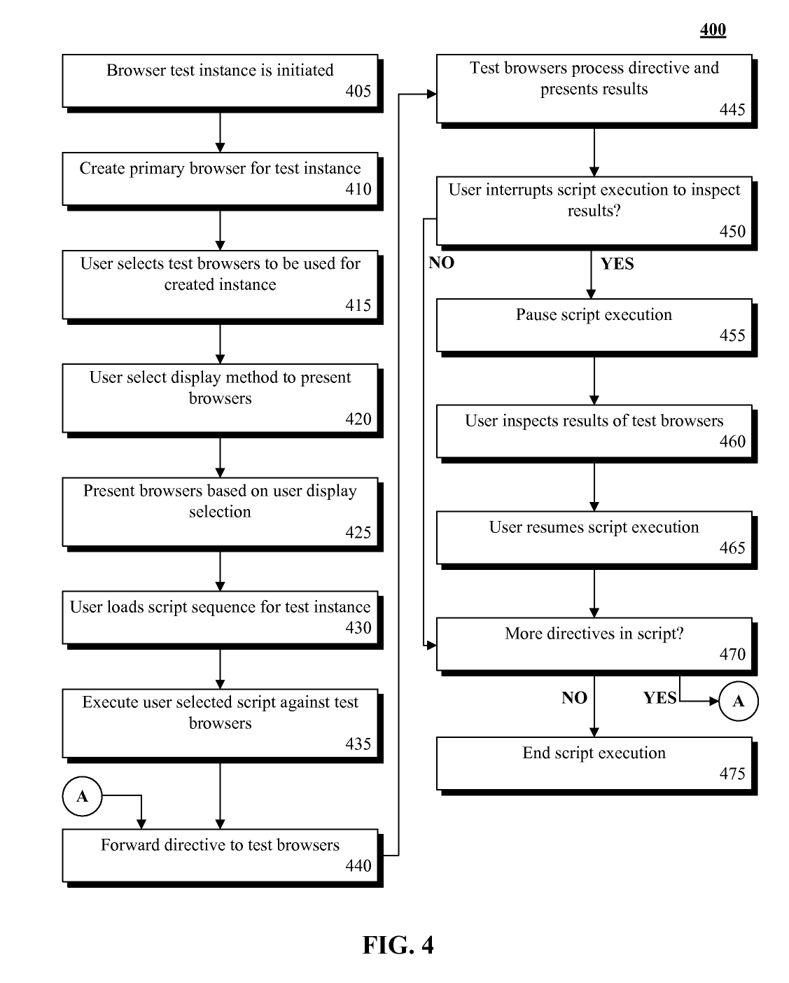

FIG. 4 is a flow chart of a method 400 for script driven intra-linked cross browser testing in accordance with an embodiment of the inventive arrangements disclosed herein. Method 400 can be performed in the context of system 100. In method 400, an interface can be utilized to perform scripted actions for testing a Web based software entity against multiple test browsers. Although the method described herein is predicated on a scripted solution, non-scripted methodologies can be contemplated.

In step 405, a browser test instance is initiated by a developer. Browser test instance can include, but is not limited to, software/application instance, project based solution, and the like. In step 410, a primary browser is created for the test instance which can be used to drive testing in the dependent browsers. In step 415, the developer selects test browsers to be used for the created instance. Browser selection can be performed from a list of available test browsers which can include local and/or remote instances of the test browsers. In step 420, the developer selects a display method to present test browsers. Presentation can include a visible mode where each browser is presented simultaneously on a viewable screen area during testing. A hidden mode can include suppression of browser presentation during testing. Both modes can include presentation of warning/alert messages in a message log notifying the developer of behavior or layout irregularities from test browsers.

In step 430, the developer loads a script sequence for the test instance. The script sequence can be an automatically generated or user created script. The script can be an interpreted, compiled, or semi-compiled program capable of performing unit testing functionality on test browsers. Script language can include, but is not limited to, JavaScript, ExtensibleStyle sheet Language Transformations (XSLT), Perl, Python, and the like. Although a script is loaded, user interaction can be substituted for the following steps 435 through 445. In step 435, the user selected script is loaded and executed against the test browsers. In step 440, script directives are forwarded to test browsers for processing. Script directives can include atomic commands, application programming interface (API) functions, and the like. For example, a script directive can be used to cause a browser to perform a hypertext transport protocol (HTTP) request for a Web page.

The diagrams in FIGS. 1-4 illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for testing Web applications comprising:
loading a Web application to a plurality of Web browsers;
receiving a plurality of user interactions with one of the Web browsers;
altering a state of the one Web browser in accordance with each user interaction;
for each received user interaction, conveying equivalent interaction data to each of the other Web browsers of the plurality of Web browsers, wherein equivalent interaction data emulates the received user interaction in context of the Web browser for which the equivalent interaction data is intended; and
altering a state of each of the other Web browsers of the plurality of Web browsers in accordance with the equivalent interaction data conveyed to each of the other Web browsers.

2. The method of claim 1, further comprising:
concurrently loading the Web application to the plurality of Web browsers; and
receiving each user interaction and altering the state of each of the plurality of Web browsers dynamically and in real-time as each of the user interactions is received.

3. The method of claim 2, wherein each of the plurality of Web browsers comprises a graphical user interface (GUI), said method further comprising;
concurrently instantiating each of the Web browsers in a graphical, multi-tasking computing environment;
granting focus to the one browser that received the plurality of user interactions; and
concurrently visually showing results of each altered state for each instantiated Web browser as each of the user interactions and the equivalent interaction data is received and processed.

4. The method of claim 1, further comprising:
detecting that one of the received user interactions that is able to be properly handled by the one Web browser lacks an exact corresponding equivalent in at least one of the other Web browsers;
determining a programmatic mapping from the one Web browser to the other Web browser lacking the equivalent; and
constructing a modified interaction data functionally equivalent to the detected received user interaction, wherein the constructed modified interaction data is configured to be properly handled by the other Web browser lacking the equivalent, wherein the equivalent interaction data conveyed to the other Web browser lacking the equivalent comprises the modified interaction data.

5. The method of claim 1, further comprising:
receiving a user command to temporarily decouple one of the plurality of web browsers from a linkage involving the other web browsers;
permitting interactions with the decoupled Web browser, which affects only that decoupled Web browser and none of the other Web browsers;
receiving a second user command to re-couple the temporarily decoupled one of the Web browsers; and
executing programmatic actions to rejoin the temporarily decoupled Web browser to the linkage to place the temporarily decoupled Web browser in a condition in which it was in before the user command to temporarily decouple the Web browser was received.

6. The method of claim 1, wherein the plurality of Web browsers are different from each other, wherein the difference is one of a browser type, a browser version of a same browser type, and a software configuration of a same browser type and version.

7. The method of claim 1, wherein said other Web browsers comprise a plurality of Web browsers.

8. A computer program product for using and interpreting a slide based motion for input, the computer program product comprising:
a computer usable medium having computer usable program code embodied therewith, the computer usable program code comprising:
computer usable program code configured to load a Web application to a plurality of Web browsers;
computer usable program code configured to receive a plurality of user interactions with one of the Web browsers;
computer usable program code configured to alter a state of the one Web browser in accordance with each user interaction;
computer usable program code configured to perform the following for each received user interaction: convey equivalent interaction data to each of the other Web browsers of the plurality of Web browsers, wherein equivalent interaction data emulates the received user interaction in context of the Web browser for which the equivalent interaction data is intended; and
computer usable program code configured to alter a state of each of the other Web browsers of the plurality of Web browsers in accordance with the equivalent interaction data conveyed to each of the other Web browsers.

9. The computer program product of claim 8, the computer usable program code comprising:
computer usable program code configured to concurrently load the Web application to the plurality of Web browsers; and
computer usable program code configured to receive each user interaction and altering the state of each of the plurality of Web browsers dynamically and in real-time as each of the user interactions is received.

10. The computer program product of claim 9, wherein each of the plurality of Web browsers comprises a graphical user interface (GUI), the computer usable program code further comprising:
computer usable program code configured to concurrently instantiate each of the Web browsers in a graphical, multi-tasking computing environment;
computer usable program code configured to grant focus to the one browser that received the plurality of user interactions; and
computer usable program code configured to concurrently visually show results of each altered state for each instantiated Web browser as each of the user interactions and the equivalent interaction data is received and processed.

11. The computer program product of claim 8, the computer usable program code further comprising:
computer usable program code configured to detect that one of the received user interactions that is able to be properly handled by the one Web browser lacks an exact corresponding equivalent in at least one of the other Web browsers;
computer usable program code configured to determine a programmatic mapping from the one Web browser to the other Web browser lacking the equivalent; and
computer usable program code configured to construct a modified interaction data functionally equivalent to the detected received user interaction, wherein the constructed modified interaction data is configured to be properly handled by the other Web browser lacking the equivalent, wherein the equivalent interaction data conveyed to the other Web browser lacking the equivalent comprises the modified interaction data.

12. A system for linking multiple browser interfaces comprising:
a primary browser interface configured to load a primary instance of at least one application, to receive input for said primary instance of the at least one application, and to present output for said primary instance of the at least one application;
at least one dependent browser interface, each configured to load a dependent instance of said least one application, to receive input for said dependent instance of at least one application, and to present output for said dependent instance of said at least one application; and
browser interface linkage executable code digitally encoded in a computing device usable medium configured to cause a computing device to link the primary browser interface and the at least one dependent browser interface so that input directed towards the primary browser interface is automatically conveyed for use by each of the dependent browser interfaces.

13. The system of claim 12, wherein said at least one dependent browser interface comprises a plurality of dependent browser interfaces.

14. The system of claim 12, wherein said primary browser interface and each of said dependent browser interfaces are interfaces of an associated Web browser, wherein the plurality of Web browsers are different from each other, wherein the difference is one of a browser type, a browser version of a same browser type, and a software configuration of a same browser type and version.

15. The system of claim 14, wherein said primary browser interface, said dependent browser interface, and said browser interface linkage are components of a software testing application, wherein said software testing application is configured to concurrently test said at least one application for said plurality of Web browsers based upon input provided to the primary browser interface.

16. The system of claim 14, wherein said primary browser interface and said at least one dependent browser interface each comprise a graphical user interface, said system comprising:
a desktop view for concurrently presenting the primary browser interface and said at least one dependent browser interface, wherein said browser interface linkage executable code is configured to convey input directed towards the primary browser interface to each of the at least one dependent browser interfaces in real time.

17. The system of claim 16, wherein said received input comprises user input, and wherein said desktop view is configured to permit a user to concurrently interact in real time with said application loaded in said plurality of Web browsers by providing user input to the primary interface only.

18. The system of claim 12, wherein the browser interface linkage executable code further comprises code for a lock-and-action mode, wherein in said lock-and-action mode the link between the primary browser interface and a selected one of the dependent browser interfaces is such that the selected dependent browser interface is configured to accept user input, which a browser linked to that selected dependent browser interface processes, wherein the accepted user input is not conveyed to any other ones of the dependent browser interfaces and is not conveyed to the primary browser interface.

19. The system of claim 12, wherein said browser interface linkage executable code comprises:
a directive handler configured to detect input entered into the primary browser interface and to convey the detected input to each dependent browser interface; and
a directive processor configured to map the detected input from one browser standard to another, wherein the directive processor converts input entered into the primary browser into a form able to be used by each of the dependent browser interfaces.

20. The system of claim 12, further comprising:
a user configuration interface configured to permit a user to designate a plurality of browsers, and to specify which interface of the designated browsers is to be considered the primary browser interface and which set of one or more interface of the designated browsers is to be considered a dependent browser interface.
